(19) United States
(12) Patent Application Publication
(10) Pub. No.: US 2009/0328119 A1
(43) Pub. Date: Dec. 31, 2009

(54) Packet Recovery Server Based Triggering Mechanism for IPTV Diagnostics

(75) Inventors: Chao Kan, Plano, TX (US); Ljubisa Tancevski, Dallas, TX (US); Tim Barrett, North Ryde (AU); Kamakshi Sridhar, Plano, TX (US)

Correspondence Address: CAPITOL PATENT & TRADEMARK LAW FIRM, PLLC, P.O. BOX 1995, VIENNA, VA, 22183, US

(73) Assignee: Alcatel Lucent, Paris (FR)

(21) Appl. No.: 12/146,359

(22) Filed: Jun. 25, 2008

(51) Int. Cl. H04N 7/173

(52) U.S. Cl. 725/107

(57) ABSTRACT

A monitoring system and method are described herein that obtain retry request information from packet recovery server(s) and based at least in part on the obtained retry request information determine whether or not to launch probes to monitor specific network element(s) within an Internet Protocol Television (IPTV) network to diagnose a problem without having to monitor everyone of the network elements all of the time.

### TECHNICAL FIELD

The present invention is related to a monitoring system and a method for detecting and diagnosing a problem within an Internet Protocol Television (IPTV) network.

2. Description of Related Art

The following abbreviations are herewith defined, at least some of which are referred to in the ensuing description of the prior art and the description of the present invention.

### BTV Broadcast Television

### Co Central Office

### DSL Digital Subscriber Line

### DSLAM Digital Subscriber Line Access Multiplexer

### IEEE Institute of Electrical and Electronics Engineers

### IGMP Internet Group Management Protocol

### IP Internet Protocol

### IPTV Internet Protocol Television

### NOC Network Operation Center

### OLT Optical Line Termination

### ONT Optical Network Termination

### OSS Operations Support System

### RGW Residential Gateway

### RTCP Real Time Control Protocol

### SAI Service Area Interface

### SHO Super Headend Office

### SNMP Simple Network Management Protocol

### STB Set-Top Box

### TV Television

### UDP User Datagram Protocol

### VHO Video Hub Office

### VLAN Virtual Local Area Network

### VoD Video-On-Demand

Referring to FIG. 1 (PRIOR ART), there is a block diagram that illustrates the basic components of an exemplary IPTV network 100 which provides broadcast TV channels to homes via for example optical fiber or DSL phone lines. The exemplary IPTV network 100 includes two SHOs 102 (routers, acquisition servers, packet recovery servers 103), a core IP network 104, multiple VHOs 106 (acquisition servers, bridges/routers, VoD servers, packet recovery servers 103), multiple aggregation network IOs 108 (routers), multiple access network COs 110 (bridges/routers), multiple SAIs 112 (DSLAMs, ONTs/OLTs) and multiple RGWs 114. The RGWs 114 are connected to STBs 116 which are connected to television sets 118 (or other monitors 118) that are located in the homes of subscribers-viewers 120. In addition, the exemplary IPTV network 100 includes a network operation center 122, packet retransmission management systems 124 (connected to the packet recovery servers 103), and a STB management system 126.

In operation, each SHO 102 receives international/national TV feeds and supplies those international/national TV feeds via the IP core network 104 to each VHO 106. Then, each VHO 106 receives regional/local TV feeds and multicasts all of the TV feeds to their respective IOs 108. Each IO 108 then multicasts at least the requested TV feeds to their respective COs 110. Then, each CO 110 multicasts all of the TV feeds to their respective SAIs 112. And, each SAI 112 then sends one or more of the TV feeds to their respective RGWs 114 and STBs 116. If a SAI 112 is in a situation where no subscribers 120 are watching a TV channel then that SAI 112 would not send any TV feeds to their respective RGWs 114 and STBs 116. Each subscriber 120 can interface with their STB 116 and select one or more of the multicast TV channels or a VOD to watch on their television set 118 (or other monitor 118). The exemplary IPTV network 100 in addition to providing broadcast TV can also provide voice (telecommunications) and data (Internet) to the homes via for example optical fiber or DSL phone lines.

As can be appreciated, it can be difficult to detect and correct a problem within the IPTV network 100 due to the many different network elements, complicated IPTV middleware-software, and many protocols that are used to support the delivery of broadcast TV, telecommunications and the Internet to subscribers 120. A traditional solution to this problem is to have the network operation center 122 rely on statistics gathered from the middleware platform and/or to insert hardware probes 128 and software probes 130 into the IPTV network 100 to collect critical network or equipment information. The hardware probes 128 can be inserted into various components or network segments of the IPTV network 100. In this example, the hardware probes 128 have been inserted into the SHOs 102, IP network 104, VHOs 106, IOs 108, COs 110 and SAIs 112. While, the middleware platform provides a form of software probes 130 that can be incorporated into various components of the IPTV network. In this example, the software probes 130 have been inserted into the RGWs 114 and the STBs 116. The data collected from these probes 128 and 130 are aggregated by the network operation center 122 where they are matched against various baselines or thresholds which are related to particular network segments. If any of the baselines or thresholds are violated, then the network operation center 122 would generate an alarm that triggers diagnosis tool(s) in an attempt to isolate and identify the problem within the IPTV network 100. However, there are several disadvantages with this existing solution:

1. The traditional solution has to monitor multiple network segments, links, or nodes and retrieve relevant parameter data all the time. This creates problematical scalability issues when the IPTV network 100 expands to support a growing number of subscribers 120 because whenever more network elements or servers are added to the IPTV network 100 then more probes 128 and 130 have to be inserted and monitored all the time.

2. The traditional solution wastes a lot of resources, which are very valuable to the network elements, client devices and servers, due to the continuous pulling of information from the probes 128 and 130. In particular, the traditional solution's continuous pulling of information from the probes 128 and 130 is especially wasteful since the IPTV network 100 should be working properly most of the time if it was designed correctly.

3. The traditional solution triggers one or more alarms whenever the relevant baseline or threshold is violated. However, it is difficult to specify and align the different baselines and thresholds which depend on various factors across multiple network segments. Plus, it is difficult to generate consistent schematics that indicate the problems with the network elements or servers because it is possible that conflicting information will be provided from different network segments when using different thresholds.

Accordingly, there is a need for a new monitoring system and method which address the aforementioned shortcomings and other shortcomings associated with the traditional solution. Plus, there is a need for a new monitoring system and method that can start IPTV diagnostics whenever and possibly before the IPTV network starts to experience a problem. These needs and other needs are satisfied by the monitoring system and method in accordance with the present invention.

### SUMMARY

In one aspect, the present invention provides a method for detecting and diagnosing a problem within an IPTV network. The method comprising the steps of: (a) obtaining retry request information from one or more packet recovery servers, where the retry request information is obtained during a first time period; (b) identifying, based on the retry request information, one or more set-top boxes which are experiencing one or more problems causing them to generate an abnormal number of retry requests or generate a retry request for an abnormal number of lost packets, where a user-defined threshold defines what is the abnormal number of retry request or what is the abnormal number of lost packets, where the set-top box(es) previously forwarded the retry requests to the one or more packet recovery servers; and (c) analyzing at least the retry request information to determine whether or not to launch probes towards the identified set-top boxes, where the probes if launched obtain information from network elements associated with the identified set-top box(es) and the obtained information is then used to diagnose a root cause and determine a location of the one or more problems within the IPTV network.

In another aspect, the present invention provides a monitoring system for detecting and diagnosing a problem within an IPTV network. The monitoring system comprising: (a) a pulling mechanism that obtains retry request information from one or more packet recovery servers, where the retry request information is obtained during a first time period; (b) a processing mechanism that processes at least the retry request information to identify one or more set-top boxes which are experiencing one or more problems which are causing them to generate an abnormal number of retry requests or generate a retry request for an abnormal number of lost packets, where a user-defined threshold defines what is the abnormal number of retry request or what is the abnormal number of lost packets, where the set-top box(es) previously forwarded the retry requests to the one or more packet recovery servers; (c) the processing mechanism analyzes the retry request information and based on a threshold determines whether or not to launch probes towards the identified set-top box(es); (d) a triggering mechanism that launches the probes towards the identified set-top box(es) where the probes obtain information from network elements associated with the identified set-top box(es); and (e) the processing mechanism processes the obtained information to diagnose a root cause and determine a location of the one or more problems within the IPTV network.

In yet another aspect of the present invention an IPTV network is provided that includes: (a) multiple set-top boxes, where each set-top box transmits a retry request when there is a problem with receiving a desired video stream; (b) a packet recovery server; and (d) a monitoring system including: (1) a processor; and (2) a memory that stores processor-executable instructions wherein the processor interfaces with the memory and executes the processor-executable instructions to: (i) obtain retry request information from the packet recovery server, where the retry request information is obtained during a first time period; (ii) identify, based on the retry request information, one or more set-top boxes which are experiencing one or more problems causing them to generate an abnormal number of the retry requests or generate the retry request for an abnormal number of lost packets, where a user-defined threshold defines what is the abnormal number of retry request or what is the abnormal number of lost packets; and (iii) analyze at least the retry request information to determine whether or not to launch probes towards the identified set-top box(es), where the probes obtain information from network elements associated with a network path to the identified set-top box(es) and the obtained information is used to diagnose a root cause and determine a location of the one or more problems.

Additional aspects of the invention will be set forth, in part, in the detailed description, figures and any claims which follow, and in part will be derived from the detailed description, or can be learned by practice of the invention. It is to be understood that both the foregoing general description and the following detailed description are exemplary and explanatory only and are not restrictive of the invention as disclosed.

### BRIEF DESCRIPTION OF THE DRAWINGS

A more complete understanding of the present invention may be obtained by reference to the following detailed description when taken in conjunction with the accompanying drawings wherein:

FIG. 1 (PRIOR ART) is a diagram of an exemplary IPTV network which is used to provide broadcast TV channels and VoD movies to homes via for example optical fiber or DSL phone lines;

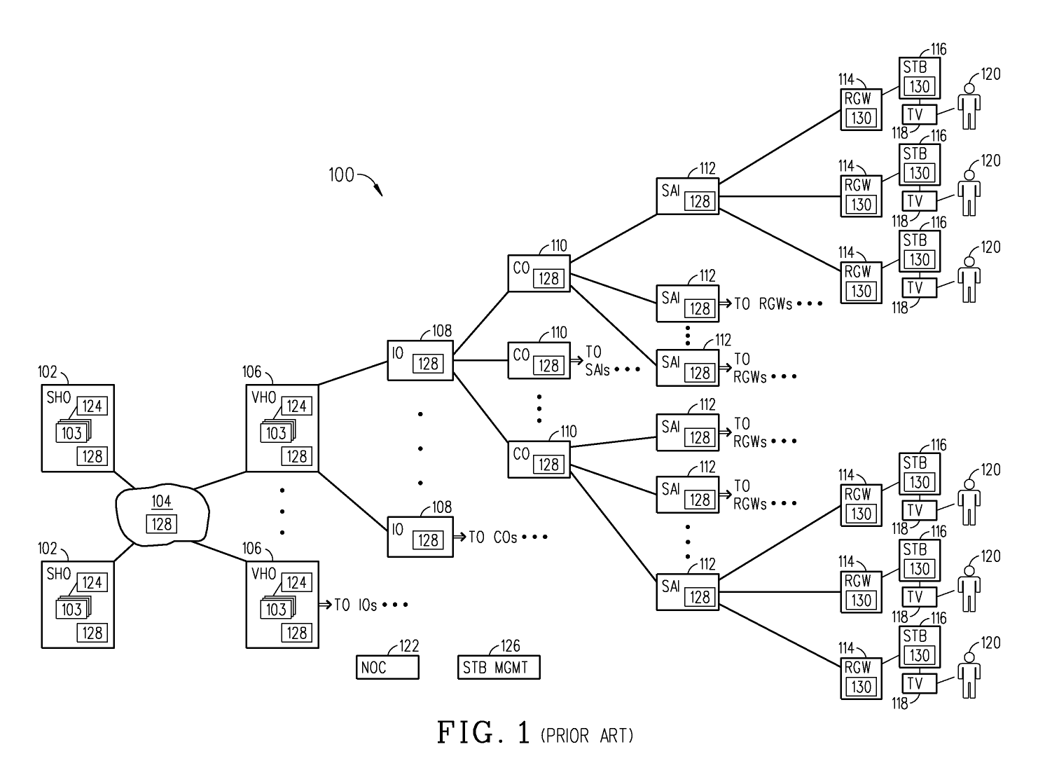

FIG. 2 is a diagram of an exemplary IPTV network which incorporates a monitoring system in accordance with an embodiment of the present invention;

FIG. 3 is a flowchart illustrating the basic steps of a method for detecting and diagnosing a problem within an IPTV network in accordance with one embodiment of the present invention; and

FIG. 4 is a flowchart illustrating the basic steps of a method for detecting and diagnosing a problem within an IPTV network in accordance with another embodiment of the present invention.

### DETAILED DESCRIPTION

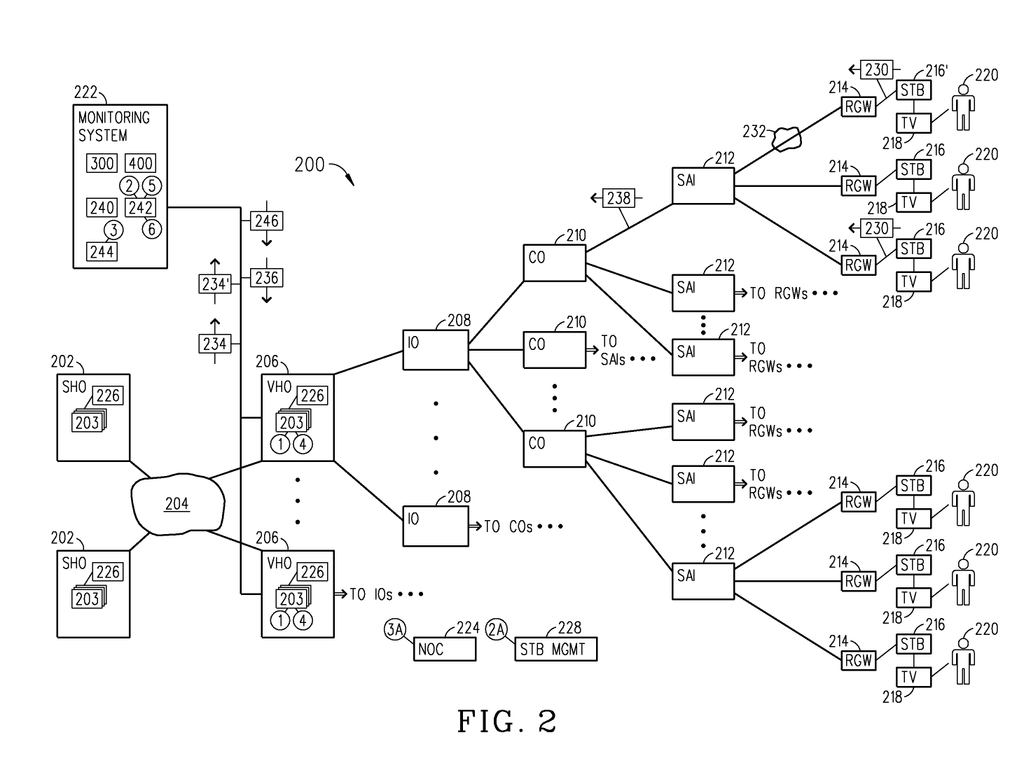

Referring to FIG. 2, there is a block diagram that illustrates an exemplary IPTV network 200 which incorporates a monitoring system 222 in accordance with an embodiment of the present invention. The exemplary IPTV network 200 includes two SHOs 202 (routers, acquisition servers, packet recovery servers 203), a core IP network 204, multiple VHOs 206 (acquisition servers, bridges/routers, VoD servers, packet recovery servers 203), multiple aggregation network IOs 208 (routers), multiple access network COs 210 (bridges/routers), multiple SAIs 212 (DSLAMs, ONTs/OLTs) and multiple RGWs 214. The RGWs 214 are connected to STBs 216 which are connected to television sets 218 (or other monitors 218) that are located in the homes of subscribers-viewers 220. In addition, the exemplary IPTV network 200 includes a network operation center 224, packet retransmission management systems 226 and a STB management system 228.

In operation, each SHO 202 receives international/national TV feeds and supplies those international/national TV feeds via the IP core network 204 to each VHO 206. Then, each VHO 206 receives regional/local TV feeds and multicasts all of the TV feeds to their respective IOs 208. And, each IO 208 then multicasts at least the requested TV feeds to their respective COs 210. Then, each CO 210 multicasts all of the TV feeds to their respective SAIs 212. Each SAI 212 then sends one or more of the TV feeds to their respective RGWs 214 and STBs 216. If a SAI 212 is in a situation where no subscribers 220 are watching a TV channel then that SAI 212 would not send any TV feeds to their respective RGWs 214 and STBs 216. Each subscriber 220 can interface with their STB 216 and select one or more of the multicast TV channels or even a VOD to watch on their television set 218 (or other monitor 218). The exemplary IPTV network 200 in addition to providing broadcast TV can also provide voice (telecommunications) and data (Internet) to the homes via for example optical fiber or DSL phone lines.

In this type of IPTV network 200, each STB 216 continuously monitors their reception buffer and can identify missing packets in a TV channel video stream that results from a packet loss somewhere upstream in the IPTV network 200. If any of these STBs 216 are missing packets then they would use this information to generate and send a retry request 230 also known as a packet loss notification-retransmission request 230 to a corresponding VHO's packet recovery server 203 which then retransmits the missing packet(s) to the requesting STB 216. In this case, the VHO's packet recovery server 203 would be considered the network end point that services the loss retry requests 230. As shown, there are packet recovery servers 203 located in the VHOs 206 but they could if desired be distributed down to and located within the IOs 208 and/or the COs 210. Also shown, there may also be separate recovery mechanisms 203 in the SHOs 202 and the VHO's packet recovery servers 203 themselves may recover lost data from these recovery mechanisms. The packet retransmission management system 226 manages one or more clusters of the packet recovery servers 203 that can also be used for fast channel change in addition to the retransmission of errored-missing packets to the STBs 216. The STB management system 228 monitors the STBs 216 and generates an alarm if anyone of the STBs 216 has difficulty sending a retry request 230.

The present invention utilizes this particular IPTV feature in which STBs 216 request the re-transmission of lost information from packet recovery servers 203 (e.g., D-servers 203 in the Microsoft Mediaroom environment). Each STB 216 can send a retry request 230 to request the retransmission of lost packets when there is, for example, network congestion, equipment failure, or operation miss-configuration from packet recovery servers 203. Thus, if anyone of the packet recovery servers 203 receive one or more “abnormal” retry request 230 from the STBs 216 then this can be a clear indication of a problem or potential problem within the IPTV network 200 (note: in the examples described herein assume the VHO's packet recovery servers 203 receive the retry requests 230 from the STBs 216 but if desired other packet recovery servers 203 could also receive the retry requests 230).

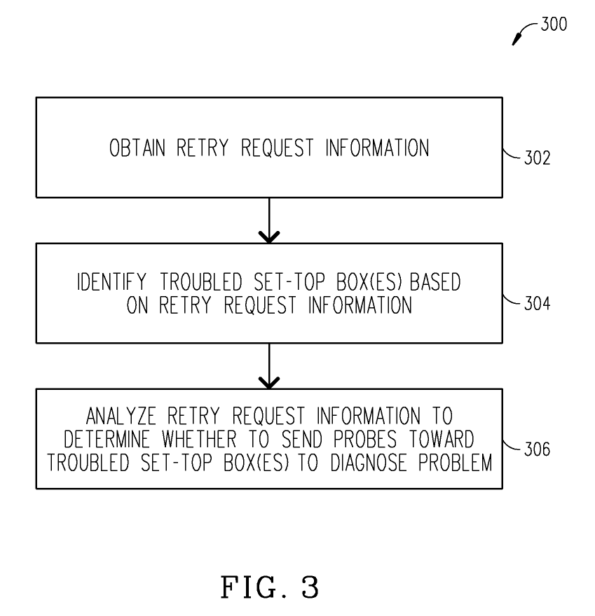

In particular, the monitoring system 222 and method 300 in accordance with an embodiment of the present invention are able to detect and diagnose one or more problems 232 within the IPTV network 200 by: (a) obtaining retry request information 234 from one or more packet recovery servers 203 (step 302 in FIG. 3); (b) identifying based on the retry request information 234 one or more STBs 216 which are experiencing problem(s) 232 causing them to generate an abnormal number of retry requests 230 or generate a retry request 230 for an abnormal number of lost packets, where a user-defined threshold defines what is an abnormal number of retry request or what is the abnormal number of lost packets, where the STB(s) 216 had forwarded the retry requests 230 to their corresponding packet recovery servers 203 (step 304 in FIG. 3); and (c) analyzing at least the retry request information 234 to determine whether or not to launch probes 236 towards the identified STB(s) 216, where the probes 236 obtain information 238 from network elements 206, 208, 210, 212 and 214 (for example) associated with the identified STB(s) 216 and the obtained information 238 is then used to diagnose a root cause and determine a location of the problem(s) 232 within the IPTV network 200 (step 306 in FIG. 3). The monitoring system 222 and method 300 are a marked-improvement over the prior art because the problem(s) 232 can be detected and diagnosed within the IPTV network 200 without having to monitor everyone of the network elements and individual segments within the IPTV network 200 all of the time.

A detailed discussion is provided next to explain one exemplary way that the monitoring system 222 can use retry request information 234 to detect and diagnose a root cause of the problem(s) 232 within the IPTV network 200 in accordance with an embodiment of the present invention. Basically, the monitoring system 222 would perform the following steps:

Step 1: The monitoring system 222 pulls retry request information 234 at a specific time scale and space scale from one packet recovery server 203 (or the packet retransmission management system 226). In particular, the monitoring system 222 has a pulling mechanism 240 the polls the session counters in the packet recovery server 203, specifically the retry request 230 counts, with respect to each STB 216 being served by this particular packet recovery server 203, in a relatively large time scale (first time scale). The relatively large time scale would be set such that it should prevent the overloading of the retry request information 234 pulled from the packet recovery server 203. The space scale would normally be set such that it scans for potential problems with all of the STBs 216 being served by this particular packet recovery server 203. Typically, the monitoring system 222 would simultaneously perform the pulling steps with multiple packet recovery servers 203 (note: steps 1-6 described in this section have been identified in FIG. 2).
Step 2: The monitoring system 222 has a processing mechanism 242 that analyzes the retry request information 234 and identifies the “troubled” STB(s) 216′ that exceed a user-defined predetermined threshold-baseline by having an abnormal number of retry requests 230 (repeated retry requests 230) or having retry requests 230 for an abnormal number of lost packets (requestedpackets>Threshold) within this large time scale (on average). Of course, not all retransmission retry requests 230 from STBs 216 would be classified as abnormal so as to signify a serious problem(s) 232 within the IPTV network 200. For example, if the STB 216 sent a retry request 230 that requested the retransmission of a small number of frames this could indicate that this small number of packets had been dropped on the access link, which is not a very serious event. Therefore, it is important for the processing means 242 to use the user-defined threshold which is configured based on observed operation and is designed to disregard packet retransmission requests that do not signify serious problem(s) 232 within the IPTV network 200.
Step 2A: The monitoring system 222 if desired may also interact with the STB management system 228 to determine if there are any additional troubled STB(s) 216′ that have not been previously identified but have a problem where, for instance, they are not sending retry requests 230 to the packet recovery server 203. If yes, then the monitoring system 222 and in particular the processing mechanism 242 would add these additional STB(s) 216′ to a list that also contains the previously identified “troubled” STBs 216′.
Step 3: The monitoring system 222 has a triggering mechanism 244 which after the troubled STB(s) 216′ have been identified and the threshold had been passed functions to launch probes 236 at specific network elements 206, 208, 210, 212 and 214 (for example) associated with the troubled STB(s) 216′. The probes 236 monitor and download parameters from the specific network elements 206, 208, 210, 212 and 214 (for example) which help to identify and diagnose the root cause of the problem(s) 232.
Step 3A: The monitoring system 222 if desired may obtain and receive alarms from other network elements like the network operation center 224 (for example) and then have the processing mechanism 242 correlate these alarms with the retry request information 234 that is associated with the identified troubled STB(s) 216′ to determine whether or not if there is a need to launch the probes 236 in the first place. In particular, there would be no need to launch the probes 236 if the other alarms identify the root cause and the location of the problem(s) 232 within the IPTV network 200. For example, a failure event could result in the triggering of a switchover, which could result in packet drop during the switchover time, but there is no need to launch probes 236 because the root cause and the location of the problem 232 are known. Therefore, it is desirable if the processing means 242 first distills only those events that result in large or repeated retry requests 230, and then correlates this information to known alarms before enabling the trigger mechanism 244 to launch the probes 236 in an attempt to identify and diagnose the root cause and the location of the problem(s) 232 in the IPTV network 200.
Step 4: While probes 236 are being launched, the monitoring system 222 can have the pulling mechanism 240 pull additional retry request information 234′ associated with the previously identified “troubled” STB(s) 216′ from the packet recovery server 203 at a shorter time scale (second time scale) and smaller space scale when compared to step 1. The processing mechanism 242 can use this information 234′ to detect repeated retransmission requests 230 or to detect if the anomaly comes from a repeated event so as to further isolate or reduce the number of troubled STB(s) 216′. This is desirable because repetition of an event may itself reveal a great deal about the nature of the problem 232, and therefore could be further analyzed by additional algorithms within the processing mechanism 242 to help identify and diagnose the root cause and the location of the problem(s) 232 in the IPTV network 200. The optimal smaller time scale would be one that allowed the processing mechanism 242 to know how many packets were requested in each STB retransmission request 230. In addition, the monitoring of only the identified “troubled” STB(s) 216′ also reduces the space scale to prevent the potential overloading resulting from the reduced time scale.
Step 5: The monitoring system 222 and in particular the processing mechanism 242 analyzes this additional retry request information 234′ to determine if any of the previously identified “troubled” STBs 216′ would violate the threshold or baseline in view of this smaller time slot (second time slot). In particular, the processing mechanism 242 can keep tracking or obtaining additional retry request information 234′ for a certain time duration to verify that these previously identified “troubled” STBs 216′ have an abnormal number of retry requests 230 or have retry requests 230 for an abnormal number of lost packets that are greater than the threshold consistently during this time period.
Step 6: The monitoring system 222 and in particular the processing mechanism 242 can combine the information of step 5 with the alarms and other information pulled from the STB management system 228 and/or the network operation center 224 to determine whether or not to have the triggering mechanism 244 launch additional probes 246 at specific network elements 206, 208, 210, 212 and 214 (for example) associated with the newly reduced number of troubled STB(s) 216′. The probes 246 monitor and download parameters from these specific network elements 206, 208, 210, 212 and 214 (for example) which help to identify and diagnose the cause of the problem(s) 232 within the IPTV network 200.
Note: the monitoring system 222 if desired may have a processor and a memory that stores processor-executable instructions wherein the processor interfaces with the memory and executes the processor-executable instructions to perform the various steps associated with the different embodiments of the present invention.

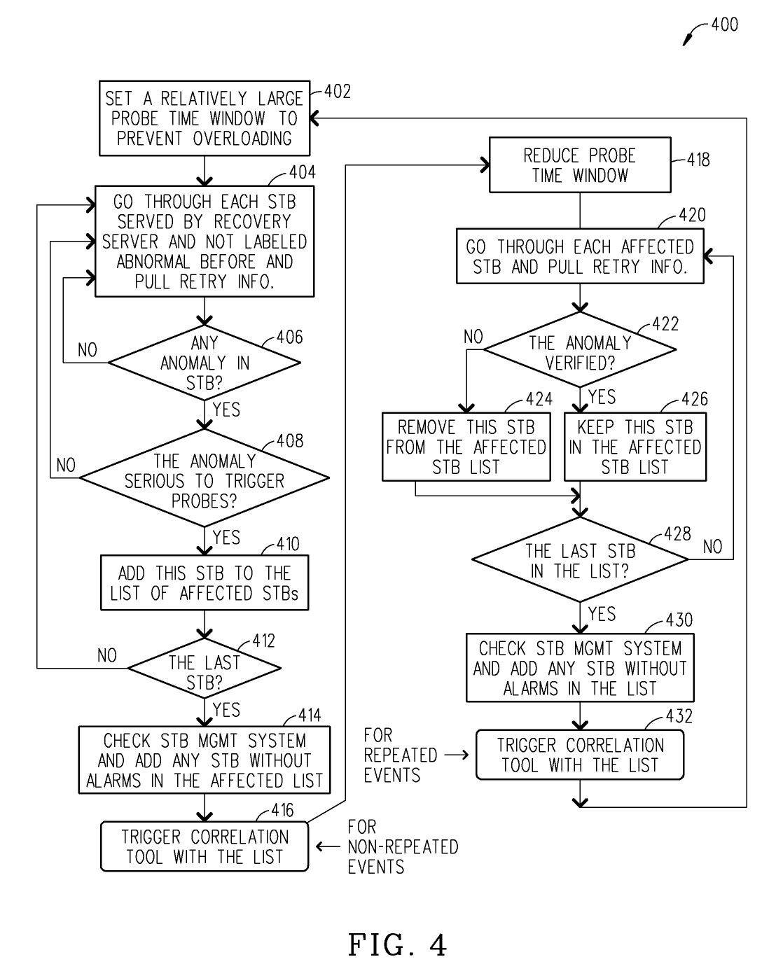

Referring to FIG. 4, there is a flowchart illustrating the basic steps of a method 400 for detecting and diagnosing problem(s) 232 within the IPTV network 200 in accordance with another embodiment of the present invention. At step 402, the monitoring system 222 sets a relatively large time window (first time window) to prevent overloading of the packet recovery server 203. At step 404, the monitoring system 222 pulls retry request information 234 from the packet recovery server 203 for one of the served STBs 216. At step 406, the monitoring system 222 analyzes the pulled retry request information 234 to determine if there is an anomaly associated with this particular STB 216. If the result of step 406 is no, then the monitoring system 222 would go back and perform step 404 to check another STB 216 that had not been previously labeled as abnormal-troubled.

If the result of step 406 was yes, then the monitoring system 222 would perform step 408 to determine if the anomaly associated with the one STB 216 is serious enough to trigger probes 236. If the result of step 408 is no, then the monitoring system 222 would go back and perform step 404 to check another STB 216 that had not been previously labeled as abnormal-troubled. Otherwise, the monitoring system 222 would perform step 410 and add this STB 216′ to the list containing the troubled-affected STBs 216′. At step 412, the monitoring system 222 checks to see if this is the last STB 216 served by the packet recovery server 203. If the result of step 412 is no, then the monitoring system 222 would go back and perform step 404 to check another STB 216 that had not been previously labeled as abnormal-troubled. Otherwise, the monitoring system 222 would perform step 414 and check with the STB management system 228 to see if any additional STBs 216 (which are not sending retry requests 230) should be added to the list containing the troubled-affected STBs 216′. At step 416, the monitoring system 222 would obtain other alarms and correlate these alarms with the retry request information 234 associated with the identified troubled STBs 216′ to determine whether or not if there is a need to launch the probes 236 in the first place. There would be no need to launch the probes 236 if the other alarms identify the root cause and the location of the problem(s) 232 within the IPTV network 200.

Assuming the probes 236 are launched in step 416, the monitoring system 222 would perform step 418 and set a relatively small time window (second time window) with which to perform the subsequent step 420. At step 420, the monitoring system 222 pulls retry request information 234′ from the packet recovery server 203 for one of the troubled STBs 216′. At step 422, the monitoring system 222 analyzes the pulled retry request information 234′ to verify if there is still an anomaly associated with the one troubled STB 216′. If the result of step 422 is no, then the monitoring system 222 would perform step 424 and remove this STB 216′ from the list containing the troubled-affected STBs 216′. If the result of step 422 is yes, then the monitoring system 222 would perform step 426 and keep this STB 216′ in the list containing the troubled-affected STB(s) 216′.

At step 428, the monitoring system 222 checks to see if this is the last troubled STB 216′ in the list containing the troubled-affected STBs 216′. If the result of step 428 is no, then the monitoring system 222 would go back and perform step 420 to pull the retry request information 234′ from the packet recovery server 203 for another one of the troubled STBs 216′. If the result of step 428 is yes, then the monitoring system 222 would perform step 430 and check with the STB management system 228 to see if any additional STB(s) 216 (which are not sending retry requests 230) should be added to the list containing the troubled-affected STB(s) 216′. At step 432, the monitoring system 222 would obtain other alarms and correlate these alarms with the recently retrieved retry request information 234′ associated with the currently identified troubled STB(s) 216′ to determine whether or not if there is a need to launch probes 246 in the first place towards the troubled STB(s) 216′ in the updated list of troubled-affected STB(s) 216′. There would be no need to launch the probes 246 if the other alarms identify the root cause and the location of the problem(s) 232 within the IPTV network 200. Finally, the monitoring system 222 returns back to step 402 and repeats the aforementioned steps 402-432.

From the foregoing, it can be appreciated that the monitoring system 222 is in charge of pulling the relevant indicators from the packet loss recovery server 203 and has threshold trigger algorithms aimed at determining, based on the pulled indicators, when a problem is serious enough to trigger launching of probes 236 at network elements to determine the cause of the problem 232. If desired, the threshold trigger algorithms in making the decision on whether to launch probes 236 could also use information pulled from the STB management server 228 to deal with the STB(s) 216 experiencing hardware or major network failure that results in no retransmission requests 230 being sent from them to the packet loss recovery server 203. A main advantage of the present invention is that it is no longer necessary to monitor every network element all the time, but rather monitor the packet loss recovery servers 203 (and possibly other elements like the STB management server 228) and based on the information from it, launch probes 236 to monitor specific network elements whenever needed. The present invention also has other advantages and other optional features some of which are as follows:

1. The monitoring system 222 may pull the retry request information 234 directly from the packet recovery servers 203 or from the packet retransmission management system 226.

2. The monitoring system 222 treats the retry requests 230 received at the packet loss recovery server 203 as a triggering event, which can indicate if the IPTV network 200 has a problem 232 because packets are being dropped. If desired, the monitoring system 222 can also be complimented by monitoring alarms from the STB management system 228 in case that some STBs 216 have a failure and can not send retry requests 230. This is a marked-improvement over existing solutions that monitor the entire IPTV network and provide triggering alarms when the threshold was violated. In addition, the existing solutions have difficulty specifying the different thresholds across multiple network segments which depend on various factors and often gives inconsistent results. This particular problem is not suffered by the monitoring system 222 of the present invention.

3. The monitoring system 222 retrieves data 234 from the packet recovery servers 203 (and possibly some other servers like the STB management server 228). So no matter how many network nodes or servers are present or added to the IPTV network 200, the monitoring system 222 still retrieves data from the packet recovery servers 203 (and possibly some other servers like the STB management server 228). This is not the case with the existing solutions which monitor all of the network segments including nodes, servers, links and have to retrieve their parameter data all the time to set potential triggering points to detect problems. The existing solutions also have another problem which can become an even bigger problem when the IPTV network expands to include more network segments since these also need to be monitored all of the time. Plus, the existing solutions waste a lot of resources during the normal network operation by having to continuously pull information and process this pulled information to detect problems in the IPTV network.

4. The monitoring system 222 would be useful to a network operator of IPTV services since they need to have an efficient diagnostic scheme for troubleshooting network problems and improving the Quality of Experience (QoE) for their end-users.

5. The monitoring system 222 can interface with many different types and many different configurations of IPTV networks beside the aforementioned exemplary IPTV network 200.

6. The monitoring system 222 may also obtain retry request information from network elements by extending the Real Time Control Protocol (RTCP) that is defined in the following two documents: (1) J. Rey et al. “RTP Retransmission Payload Format” RFC 4588, July 2006, pp. 1-45; and (2) J. Ott et al. “Extended RTP Profile for Real-Time Transport Control Protocol (RTCP)-Based Feedback (RTP/AVPF)” RFC 4585, July 2006, pp. 1-65. The contents of these two documents are hereby incorporated by reference herein. The standardized RTCP is generally used to transmit the end-to-end quality statistical information about the RTP session to each participant. And, since the standardized RTCP does not give any information about which packets were lost it tried to enable more accurate and immediate action on network problems, and in the best case, allows information on loss (NACK) or receipt (ACK) of RTP packets in a round-trip time. Thus, in a RTCP based packet recovery system there is typically a network element which acts in a similar fashion to the aforementioned packet recovery server 203. In this instance, the recovery data (retry request information) would be polled from this network element rather than from a packet recovery server 203.

Although multiple embodiments of the present invention have been illustrated in the accompanying Drawings and described in the foregoing Detailed Description, it should be understood that the present invention is not limited to the disclosed embodiments, but is capable of numerous rearrangements, modifications and substitutions without departing from the invention as set forth and defined by the following claims.

1. A method for detecting and diagnosing a problem within an Internet Protocol Television (IPTV) network, said method comprising the steps of:
obtaining retry request information from one or more packet recovery elements-servers, where the retry request information is obtained during a first time period;
identifying, based on the retry request information, one or more set-top boxes which are experiencing one or more problems causing them to generate an abnormal number of retry requests or generate a retry request for an abnormal number of lost packets, where a user-defined threshold defines what is the abnormal number of retry request or what is the abnormal number of lost packets, where the set-top box(es) previously forwarded the retry requests to the one or more packet recovery elements-servers; and
analyzing at least the retry request information to determine whether or not to launch probes towards the identified set-top box(es), where the probes if launched obtain information from network elements associated with the identified set-top box(es) and the obtained information is then used to diagnose a root cause and determine a location of the one or more problems within the IPTV network.

2. The method of claim 1, further comprising the steps of determining if there are any set-top boxes which are not generating retry requests and then adding those set-top boxes to a list containing the identified set-top boxes.

3. The method of claim 1, wherein said step of analyzing at least the retry request information further includes steps of obtaining other alarms, correlating the other alarms with the retry request information, and determining that there would be no need to launch the probes if the other alarms identified the root cause and the location of the one or more problems within the IPTV network.

4. The method of claim 1, further comprising a step of obtaining additional retry request information from the one or more packet recovery elements-servers, where the additional retry request information had been generated by the identified set-top box(es) and was obtained during a second time period which is less than the first time period.

5. The method of claim 4, further comprising a step of analyzing the additional retry request information to detect repeated retry requests and reduce a number of the identified set-top box(es) and to determine whether or not to launch additional probes towards the reduced identified set-top box(es), where the additional probes obtain additional information from the network elements associated with the reduced identified set-top box(es) and the obtained additional information is used to diagnose the root cause and determine the location of the one or more problems within the IPTV network.

6. The method of claim 5, wherein said step of analyzing the additional retry request information further includes steps of obtaining additional alarms, correlating the additional alarms with the additional retry request information, and determining that there would be no need to launch the additional probes if the additional alarms identify the root cause and the location of the one or more problems within the IPTV network.

7. The method of claim 5, further comprising the steps of determining if there are any set-top box(es) that are not generating retry requests and adding those set-top box(es) to a list containing the reduced identified set-top box(es).

8. The method of claim 1, wherein the retry request information is obtained indirectly from the one or more packet recovery elements-servers via a packet retransmission management system.

9. The method of claim 1, wherein the user-defined threshold is configured based on observed operation and is designed to disregard packet retransmission requests that do not signify serious problem(s) within the IPTV network.

10. A monitoring system for detecting and diagnosing a problem within an Internet Protocol Television (IPTV) network, said monitoring system comprising:
a pulling mechanism that obtains retry request information from one or more packet recovery elements-servers, where the retry request information is obtained during a first time period;
a processing mechanism that processes the retry request information to identify one or more set-top boxes which are experiencing one or more problems which are causing them to generate an abnormal number of retry requests or generate a retry request for an abnormal number of lost packets, where a user-defined threshold defines what is the abnormal number of retry request or what is the abnormal number of lost packets, where the set-top box(es) previously forwarded the retry requests to the one or more packet recovery elements-servers;
said processing mechanism analyzes at least the retry request information and based on a threshold determines whether or not to launch probes towards the identified set-top box(es);
a triggering mechanism that launches the probes towards the identified set-top box (es) where the probes obtain information from network elements associated with the identified set-top box(es); and
said processing mechanism processes the obtained information to diagnose a root cause and determine a location of the one or more problems within the IPTV network.

11. The monitoring system of claim 10, wherein said processing mechanism determines if there are any set-top box(es) that are not generating retry requests and then adds those set-top box(es) to a list containing the identified set-top box(es).

12. The monitoring system of claim 10, wherein said processing mechanism obtains other alarms, correlates the other alarms with the retry request information, and determines that there would be no need to launch the probes if the other alarms identified the root cause and the location of the one or more problems within the IPTV network.

13. The monitoring system of claim 12, wherein said processing mechanism obtains additional retry request information from the one or more packet recovery elements-servers, where the additional retry request information had been generated by the identified set-top box(es) and was obtained during a second time period which is less than the first time period.

14. The monitoring system of claim 13, wherein said processing mechanism analyzes the additional retry request information to detect repeated retry requests and further reduce a number of the identified set-top box(es) and to determine whether or not to launch additional probes towards the reduced identified set-top box(es), where the additional probes obtain additional information from the network elements associated with the reduced identified set-top box(es) and the obtained additional information is used to diagnose the root cause and determine the location of the one or more problems within the IPTV network.

15. The monitoring system of claim 14, wherein said processing mechanism obtains additional alarms, correlates the additional alarms with the additional retry request information, and determines that there would be no need to launch the additional probes if the additional alarms identified the root cause and the location of the one or more problems within the IPTV network.

16. The monitoring system of claim 14, wherein said processing mechanism determines if there are any set-top box(es) that are not generating retry requests and adds those set-top box(es) to a list containing the reduced identified set-top box(es).

17. The monitoring system of claim 14, wherein the pulling mechanism obtains the retry request information indirectly from the one or more packet recovery elements-servers via a packet retransmission management system.

18. An Internet Protocol Television Network (IPTV) comprising:
a plurality of set-top boxes, each set-top box transmits a retry request when there is a problem with receiving a desired video stream;
a packet recovery element-server that receives the retry requests transmitted by the set-top box(es); and
a monitoring system including:
a processor; and
a memory that stores processor-executable instructions wherein the processor interfaces with the memory and executes the processor-executable instructions to:
obtain retry request information from the packet recovery element-server, where the retry request information is obtained during a first time period;
identify, based on the retry request information, one or more set-top box(es) which are experiencing one or more problems causing them to generate an abnormal number of the retry requests or generate the retry request for an abnormal number of lost packets, where a user-defined threshold defines what is the abnormal number of retry request or what is the abnormal number of lost packets; and
analyze at least the retry request information to determine whether or not to launch probes towards the identified set-top box(es), where the probes obtain information from network elements associated with a network path to the identified set-top box(es) and the obtained information is used to diagnose a root cause and determine a location of the one or more problems.

19. The IPTV network of claim 18, wherein said monitoring system further determines if there are any set-top box(es) that are not generating retry requests and then adds those set-top box(es) to a list containing the identified set-top box(es).

20. The IPTV network of claim 18, wherein said monitoring system further obtains other alarms, correlates the other alarms with the retry request information, and determines that there would be no need to launch the probes if the other alarms identified the root cause and the location of the one or more problems within the IPTV network.

21. The IPTV network of claim 18, wherein said monitoring system further obtains additional retry request information from the packet recovery element-server, where the additional retry request information had been generated by the identified set-top box(es) and is obtained during a second time period which is less than the first time period.

22. The IPTV network of claim 21, wherein said monitoring system further analyzes the additional retry request information to detect repeated retry requests and reduce a number of the identified set-top box(es) and to determine whether or not to launch additional probes towards the reduced identified set-top box(es), where the additional probes obtain additional information from the network elements associated with the reduced identified set-top box(es) and the obtained additional information is used to diagnose the root cause and determine the location of the one or more problems within the IPTV network.

23. The IPTV network of claim 22, wherein said monitoring system further obtains additional alarms, correlates the additional alarms with the additional retry request information, and determines that there is no need to launch the additional probes if the additional alarms identified the root cause and the location of the one or more problems within the IPTV network.

24. The IPTV network of claim 22, wherein said monitoring system further determines if there are any set-top boxes that are not generating retry requests and adds those set-top boxes to a list containing the reduced identified set-top boxes.

25. The IPTV network of claim 18, where said monitoring system obtains the retry request information indirectly from the packet recovery element-server via a packet retransmission management system.
